(19) United States
(12) Patent Application Publication
(10) Pub. No.: US 2014/0047409 A1
(43) Pub. Date: Feb. 13, 2014

(54) ENTERPRISE APPLICATION DEVELOPMENT TOOL

(71) Applicants: Edward YANG, San Jose, CA (US); Robyn J. Chan, San Francisco, CA (US); Hanju Kim, Palo Alto, CA (US)

(72) Inventors: Edward YANG, San Jose, CA (US); Robyn J. Chan, San Francisco, CA (US); Hanju Kim, Palo Alto, CA (US)

(73) Assignee: Magnet Systems Inc., Palo Alto, CA (US)

(21) Appl. No.: 13/584,737

(22) Filed: Aug. 13, 2012

(51) Int. Cl. G06F 9/44

(52) U.S. Cl. 717/105

(57) ABSTRACT

Systems and processes for providing an application development tool are disclosed. The application development tool may include a user interface that allows a user to select and modify widgets, map API properties to widget attributes, and create application user interfaces using the widgets. To modify the widgets and create applications, the application development tool may edit the source code associated with the widget or application based on input received from the user via the application development tool interface.

### BACKGROUND

1. Field

The present disclosure relates to application development and, in one particular example, to application development tools.

2. Related Art

Application development tools are commonly used by software application developers to rapidly generate user interface (UI) elements, commonly called “widgets,” by leveraging popular UI libraries connected to a backend service. These widgets are typically designed to interact with the backend via application programming interfaces (APIs). The application development tools provide visual previews of the widgets and also allow widget customization using an accompanying UI or built-in source code editor.

While existing application development tools provide UIs for developing a single widget, these tools do not provide support for the creation and combination of multiple widgets. Moreover, conventional application development tools lack intuitive what you see is what you get (WYSIWYG) ability and lack sufficient integration with the APIs. As a result, the developer must write code to access the APIs and to render the UI widgets.

### SUMMARY

Processes for developing an application are described. The process may include receiving a selection of a first widget, wherein the first widget includes at least one widget attribute. The process may further include causing a display of a first set of available properties that can be mapped to the at least one widget attribute of the first widget, receiving a selection of a property of the first set of available properties to be mapped to the at least one widget attribute of the first widget, and mapping the selected property of the first set of available properties to the at least one widget attribute of the first widget. The process may further include receiving a request to include the first widget within an application and including the first widget within the application.

In some examples, the process my further include receiving a selection of a second widget, wherein the second widget includes at least one widget attribute, causing a display of a second set of available properties that can be mapped to the at least one widget attribute of the second widget, receiving a selection of a property of the second set of available properties to be mapped to the at least one widget attribute of the second widget, mapping the selected property of the second set of available properties to the at least one widget attribute of the second widget, receiving a request to include the second widget within the application, and including the second widget within the application. The process may further include exporting the application as a plurality of files.

In some examples, the first set of available properties may be selected from a plurality of properties based on the at least one widget attribute of the first widget. In other examples, mapping the selected property may include modifying source code associated with the first widget to associate the selected property of the first set of available properties to the at least one widget attribute of the first widget using a pre-generated segment of code.

In some examples, the process may further include causing a display of an application development tool interface, wherein the application development tool interface includes: a widget selection interface for displaying a representation of a plurality of widgets, a widget preview interface for displaying a preview of the first widget, and an application preview interface for displaying a preview of the application. In some examples, receiving the selection of the first widget may include receiving a selection of the first widget from the plurality of widgets displayed within the widget selection interface. In other examples, receiving the request to include the first widget within the application may include receiving a selection of the first widget displayed within the widget preview interface and receiving a placement of the first widget within the preview of the application displayed within the application preview interface.

In some examples, the process may further include causing a display of source code associated with the first widget within the widget preview interface and causing a display of source code associated with the application within the application preview interface. In some examples, including the first widget within the application may include modifying source code associated with the application based on source code associated with the first widget.

Systems and non-transitory computer-readable storage media for developing an application are also described.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary environment for carrying out certain aspects and examples of the embodiments described herein.

FIG. 2 illustrates an exemplary process for developing an application.

FIG. 3 illustrates an exemplary interface for developing an application.

FIG. 4 illustrates an exemplary interface for mapping API properties to widget attributes.

FIG. 5 illustrates an exemplary interface for viewing and editing widget and application source code.

FIG. 6 illustrates an exemplary interface for viewing and editing widget and application settings.

FIG. 7 illustrates an exemplary interface for displaying a full-screen view of a developed application.

FIG. 8 illustrates an exemplary computing system that may be used to carry out the various embodiments described herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

Various embodiments are described below relating systems and processes for providing an application development tool. The application development tool may include a user interface that allows a user to select and modify widgets, map API properties to widget attributes, and create application user interfaces using the widgets. To modify the widgets and create applications, the application development tool may edit the source code associated with the widget or application based on input received from the user via the application development tool interface.

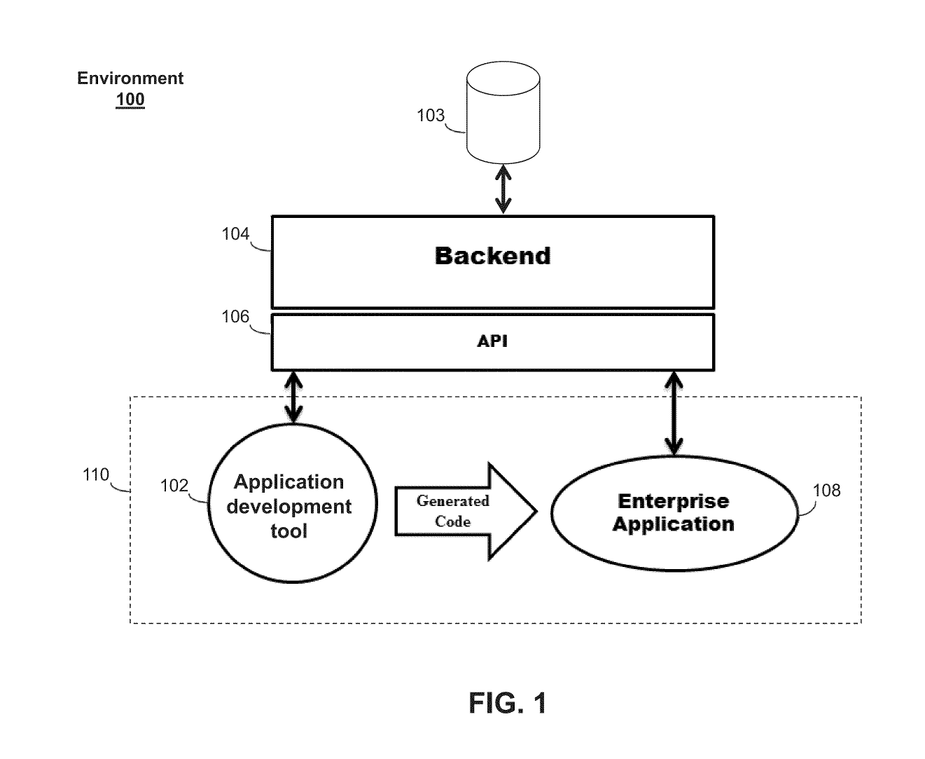

FIG. 1 illustrates a block diagram of an exemplary environment 100 showing the relationship between a backend 104 and clients 110. Unlike typical application development environments, the application development tool 102 may communicate with the backend 104 using API 106. The application 108 (e.g., an enterprise application) may be fully or partially developed using the application development tool 102. For example, application 108 may be a web application that runs in a web browser, a program application that runs on a mobile device, an interpreted program that runs on a desktop computer, or the like.

In one example, application development tool 102 may query the backend 104 for API definitions. The backend 104 may determine a list of available API definitions and return the list to the application development tool 102 in response to the query.

The backend system 104 may have access to one or more local or remote databases 103 (e.g., a widget library, such as Wijmo, JQuery Mobile, or the like). The databases 103 may store data that the backend system 104 makes available to clients 110 through API 106. In one example, the backend system 104 and the databases 103 may be running on the same server. In another example, the backend system 104 and the databases 103 may be running on different servers. In yet another example, clients 110 may be running on the same server as the backend system 104 and the databases 103. In another example, each of the clients 110, the backend system 104, and the databases 103 may be running on different servers. One of skill in the art will appreciate that other variations may also be used.

Similarly, application 108, which may be developed using application development tool 102, may also access the backend system 104 using the API 106. Application 108 may use API 106 to access the functionality of backend system 104. This may include reading and writing data to databases 103.

The application development tool 102 may generate or select computer code, which is used to develop application 108. Computer code 108 may include program source code, such as C, C++, Pascal, Assembly code, JavaScript, or any other program source code in any computer language. Computer code may also include markup code, such as hypertext markup language (html), extensible markup language (XML), xhtml, css, vector graphics markup language, or any other markup code in any computer language. In one example, the computer code may be used directly by the application development tool 102, such as by performing all or some of the steps necessary for creating a computer application or computer display, in order to aid a user in the development of application 108. These steps may include interpreting, compiling, assembling, linking, and/or loading the computer code. In another example, the computer code may be copied or transferred to a different development tool or system to aid in the development of application 108. Additionally, as will be described in greater detail below, the application development tool 102 can be used to design an application UI having one or more widgets, map API properties to properties of the widgets, edit source code of the application and widgets, modify settings of the applications and widgets, and the like.

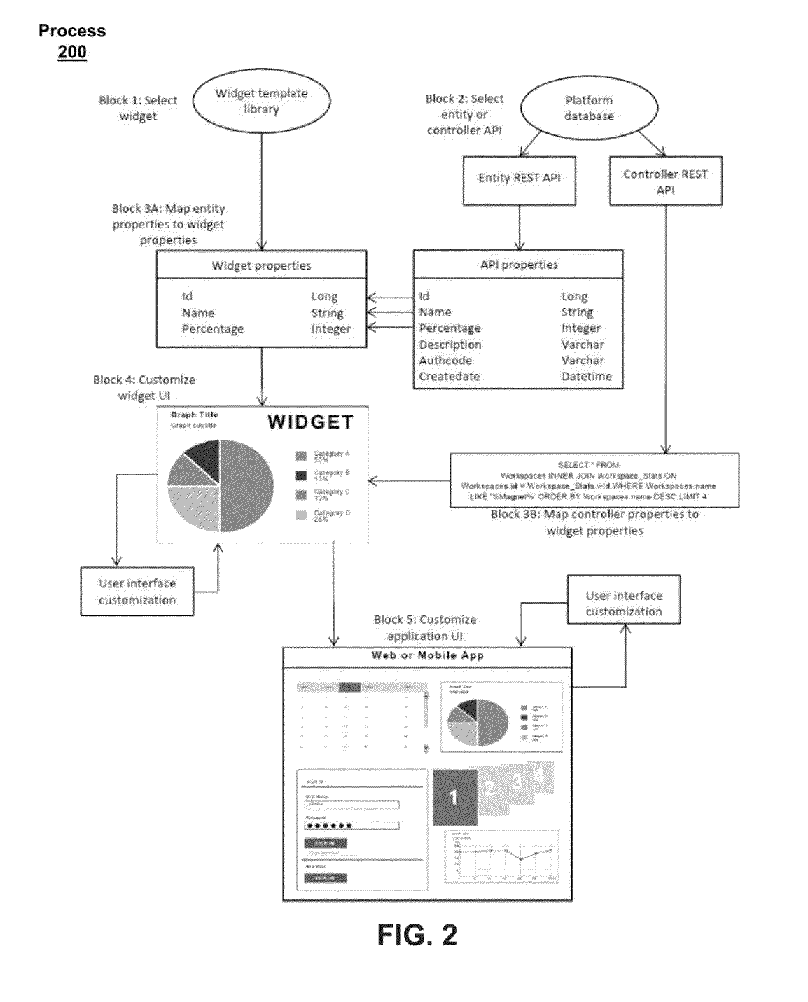

FIG. 2 illustrates an exemplary process 200 for developing an application using an application development tool, such as application development tool 102, according to various embodiments. At block 1 of process 200, a widget may be selected from a widget library. For example, a widget may be selected from a local or remote database, such as Wijmo, JQuery Mobile, and the like, containing publicly available or customized widgets.

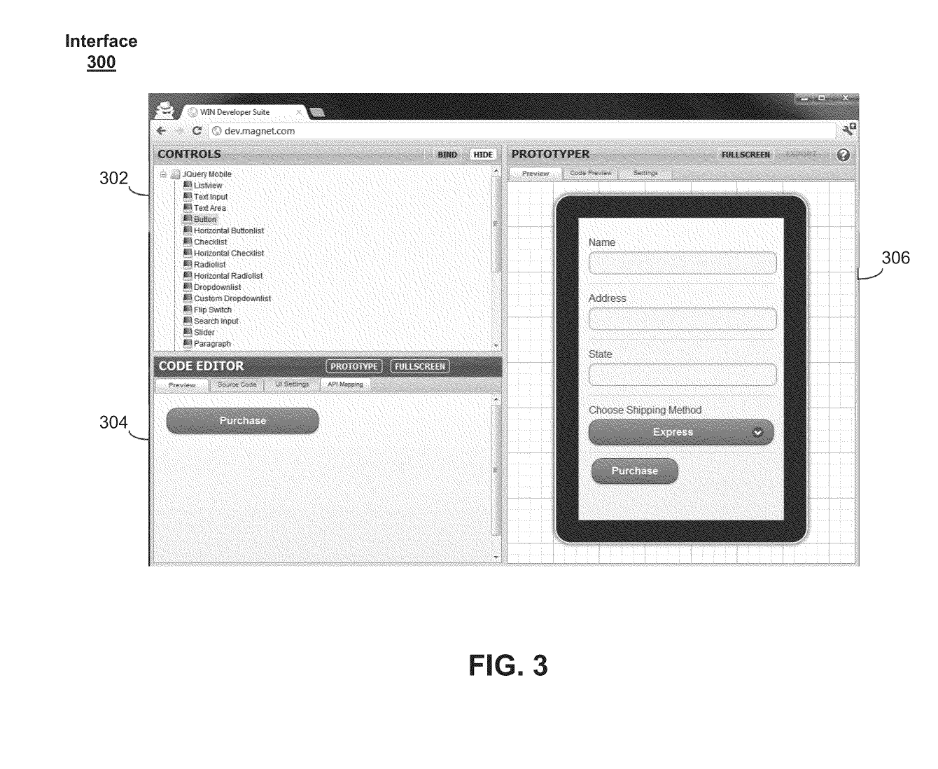

In some examples, an application development tool (e.g., application development tool 102) having an interface similar or identical to interface 300 shown in FIG. 3, may be provided to allow the user to select the widget at block 1. As shown in FIG. 3, interface 300 may include widget selection interface 302 for displaying a list of one or more widgets from a local or remote database. To obtain the one or more widgets, the application development tool may access the local or remote database and populate interface 302 with the widgets available from the database(s). The widgets may be listed in interface 302 under one or more directories corresponding to each of the local or remote databases. In response to a selection of a directory, the list of available widgets contained in the database corresponding to the selected directory may be displayed. For example, FIG. 3 shows an expanded view of the “JQuery Mobile” directory, which corresponds to the “JQuery Mobile” database. Listed beneath the “JQuery Mobile” directory is the list of available widgets, such as “Listview,” “Text Input,” “Text Area,” “Button,” etc., contained in the “JQuery Mobile” database. While a specific example interface 302 is provided, it should be appreciated that other interface elements may be provided to display one or more available widgets to the user and allow the user to selected a desired widget.

In some examples, interface 300 may further include widget preview interface 304 for displaying a preview of data associated with a widget selected in widget selection interface 302. For example, FIG. 3 shows the “Button” widget selected in widget selection interface 302 and its selection is indicated by the highlighted “Button” text. As a result, a visual representation of the button widget is displayed within widget preview interface 304 when the “Preview” tab is selected. In this particular example, the button includes the text “Purchase.” However, the text can be replaced with any desired text using widget preview interface 304 of the application development tool. As will be described in greater detail below, interface 304 may further include “Source Code,” “UI Settings,” and “API Mapping” tabs. While a specific example interface 304 is provided, it should be appreciated that other interface elements may be provided to preview a selected widget.

Thus, at block 1 of process 200, the application development tool may access a local or remote widget database (e.g., the “JQuery Mobile” database) and may display a visual representation of the local or remote database along with one or more widgets contained within the database(s) in widget selection interface 302. The application development tool may further receive a selection of a particular widget (e.g., by a user clicking, or otherwise selecting, a widget) listed in the widget selection interface 302. In response to receiving the user's selection of the widget, the application development tool may access or otherwise receive the selected widget from the appropriate database (or access a locally stored copy of the widget). The received widget (or properties thereof) may then be displayed in widget preview interface 304.

At block 2 of process 200, the user can determine whether the widget selected at block 1 should interact with the backend platform via entity APIs or if the widget selected at block 1 should interact with the backend platform via controller APIs.

If, at block 2, it is determined that a backend entity API is to be used, the process may proceed to block 3A. At block 3A of process 200, entity properties may be mapped to widget attributes. For example, the widget selected at block 1 may include one or more widget attributes, such as “id,” “name,” “percentage,” or the like. In this example, API properties, such as “id,” “name,” “percentage,” of the selected backend entity may be mapped to the corresponding widget attributes. In some examples, to obtain the available API properties, the application development tool may query the backend platform for API definitions.

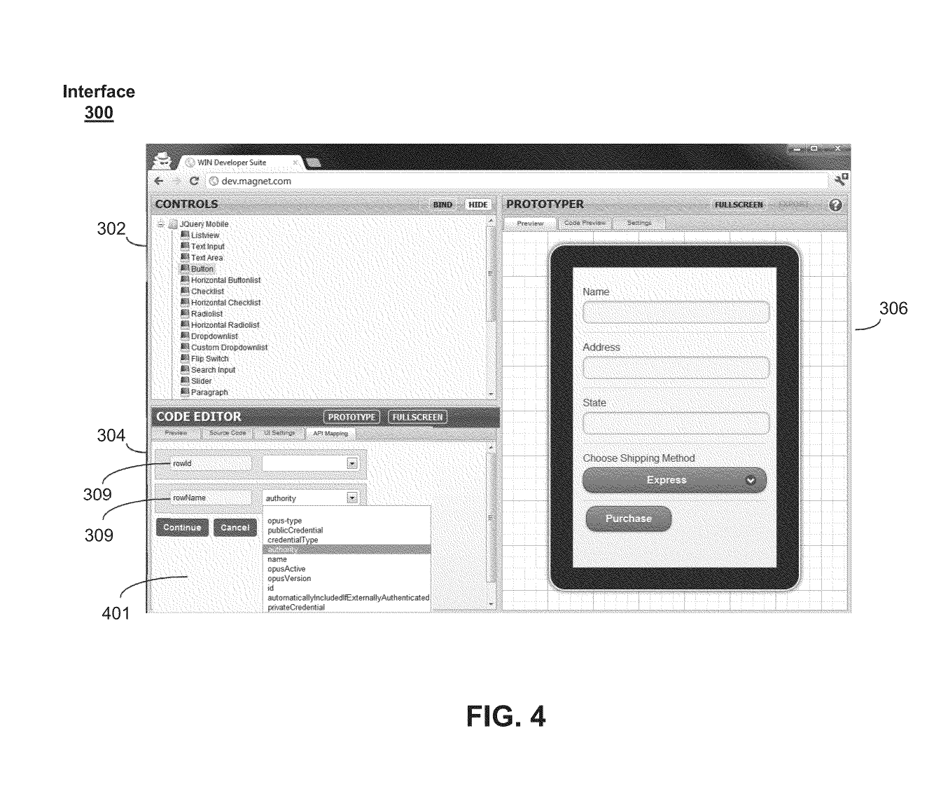

In some examples, the application development tool having an interface similar or identical to interface 300 may be provided to allow the user to map the API properties to the attributes of the widget selected at block 1. For example, in response to a selection of the “API Mapping” tab of interface 304, menu 401, shown in FIG. 4, may be displayed. Menu 401 may include one or more widget attributes 309 associated with the widget selected at block 1 and a pull-down menu (or other interface element to allow a user to select an item from a list) containing one or more available API properties. In some examples, the API properties contained in the pull-down menu may be generated based on the available API properties for the corresponding widget attribute of the selected widget. For example, any of the API properties “opus-type,” “publicCredential,” “credentialType,” “authority,” “name,” etc., may be mapped to the widget attribute “rowName.” As a result, the pull-down menu associated with widget attribute “rowName” may include these available API properties. Menu 401 may display a similar list of API properties in response to a selection of the pull-down menu associated with the “rowID” widget attribute. However, the list of API properties for the “rowID” attribute may be the same or different than the list provided for the “rowName” attribute depending on the API properties available for the “rowID” attribute. Once the desired API properties are selected, the “Continue” button may be selected and the application development tool may map the selected API properties to the widget attributes. To map the selected API properties to the widget attributes, the application development tool may modify the source code of the widget by inserting pre-generated segments of code (e.g., JavaScript or other programming language) in response to a request to map the selected API properties to the widget attributes.

Thus, at block 3A of process 200, the application development tool may access or otherwise receive a list of available API properties that can be associated with one or more widget attributes of the widget selected at block 1. The application development tool may cause a display of the available API properties within menu 401 and may receive a selection of an API property to map to an attribute of the widget. In response to a mapping selection, the application development tool may map the selected API property to the associated widget attribute. The application development tool may map the selected API property to the associated widget attribute by editing the source code of the widget using pre-generated segments of code (e.g., JavaScript or other programming language). In this way, the user may map API properties to widget attributes without knowledge of the available API properties and without having to program the mapping in, for example, JavaScript or another programming language.

If, however, a backend controller REST API is selected at block 2, the process may proceed to block 3B. At block 3B of process 200, the application development tool may access backend controller APIs to provide customized interaction with the backend in order to map to the widget selected at block 1. The application development tool may provide the same or a similar interface 300 having menu 401 as provided at block 3A, but may instead map controller properties to the widget attributes. The application development tool may edit source code associated with the selected widget using pre-generated segments of code (e.g., JavaScript or other programming language) in response to a request to map the selected API properties to the widget attributes.

Thus, at block 3B of process 200, the application development tool may access or otherwise receive a list of available API properties from a database that can be associated with one or more widget attributes of the widget selected at block 1. The application development tool may cause a display of the available API properties and may receive a selection of an API property to map to an attribute of the widget. In response to a mapping selection, the application development tool may map the selected API property to the associated widget attribute. The application development tool may map the selected API property to the associated widget attribute by editing the source code of the widget using pre-generated segments of code (e.g., JavaScript or other programming language). In this way, the user may map API properties to widget attributes without knowledge of the available API properties and without having to program the mapping in, for example, JavaScript or another programming language.

Once the desired API properties are mapped to the widget attributes at either block 3A or 3B, the process may proceed to block 4. At block 4 of process 200, the widget may be displayed using the mapped API properties, allowing the user to review and edit the widget. For example, text displayed on the widget, API property mappings, source code, settings, action mapping (e.g., a button widget can have a “click” action mapped to it that will call an entity API to update data or a dropdown menu widget can display data received from an entity API), and the like, can be edited using interface 300 of the application development tool. In some examples, the widget appearance can be viewed using the “Preview” tab in interface 304, the source code of the widget can be viewed and edited using the “Source Code” tab in interface 304, the widget settings (e.g., label text, dropdown items, themes, and the like) can be viewed and edited using the “UI Settings” tab in interface 304, and API property mappings can be viewed and edited using the “API Mappings” tab in interface 304.

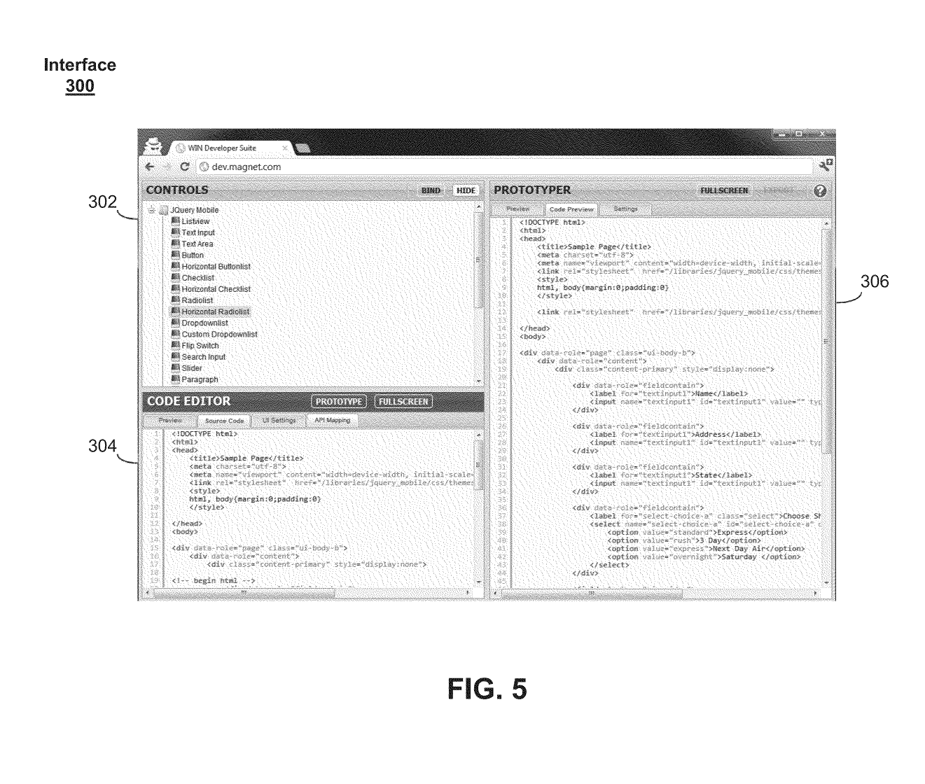

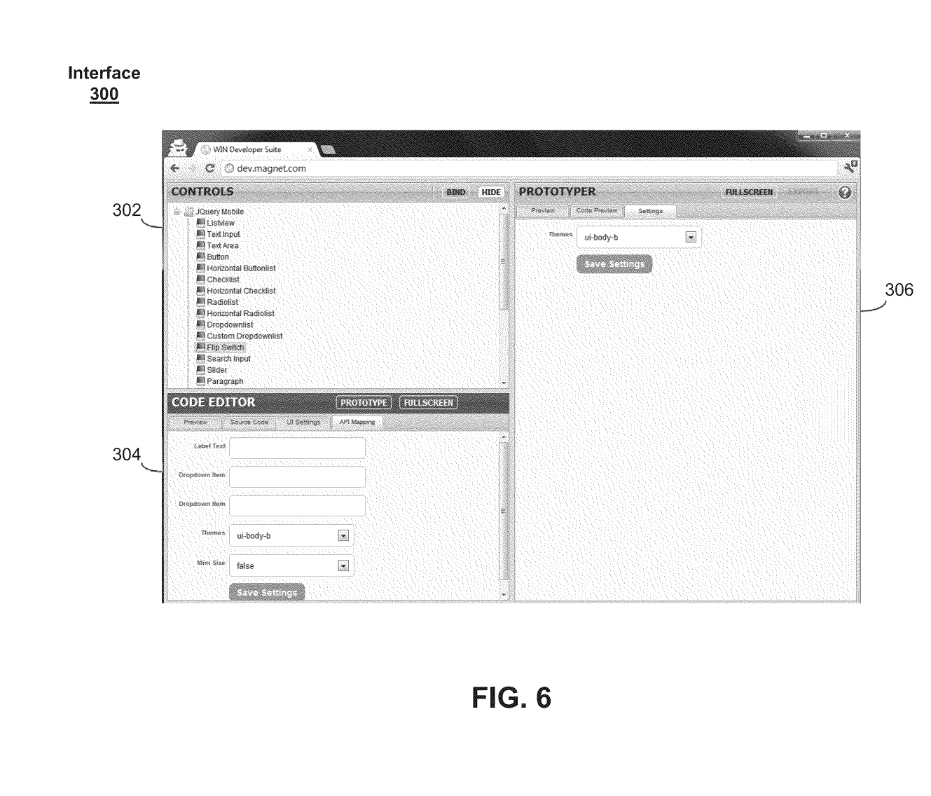

To illustrate, FIG. 5 shows an example view of widget preview interface 304 when the “Source Code” tab is selected. Specifically, the source code associated with the selected widget (e.g., “Horizontal Radiolist”) may be displayed within interface 304. A user may directly edit the displayed source code and the application development tool may apply the edited source code to the selected widget. FIG. 6 shows an example view of widget preview interface 304 when the “UI Settings” tab is selected. Specifically, available settings, such as “Label Text,” “Dropdown Item,” “Themes,” and “Mini Size,” associated with the selected widget (e.g., “Flip Switch”) may be displayed within interface 304. A user may type or select an option from a pull-down menu within interface 304 and the application development tool may apply the entered/selected options to the selected widget by editing the source code associated with the widget. Using the various options provided in widget preview interface 304, the user may view and edit a selected widget until the widget includes the properties and appearance desired by the user. By providing a graphical user interface (e.g., under the “Settings” or “Mappings” tab) and a source code view (e.g., under the “Source Code” tab), the application development tool allows a user to modify the widget by directly editing the source code or by using an intuitive interface that does not require programming knowledge.

Thus, at block 4 of process 200, the application development tool may cause a display of a visual representation, source code, settings, and API property mappings associated with the widget selected at block 1. The application development tool may further receive one or more changes to the displayed information associated with the widget and may apply those changes. In some examples, the received changes may include changes to the source code associated with the widget. In other examples, the changes may include input received in a graphical user interface that may cause the application development tool to edit the source code associated with the widget using pre-generated segments of code.

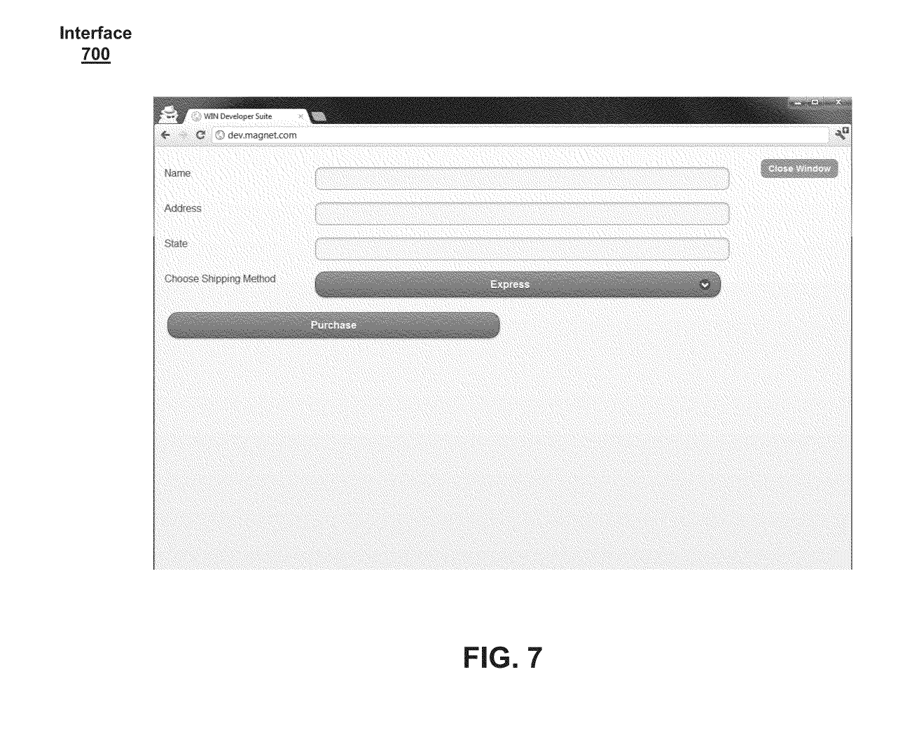

Once the user has finished editing a selected widget, the process may proceed to block 5. At block 5 of process 200, an application UI may be generated by adding the widget to the UI. In some examples, the application development tool having an interface similar or identical to interface 300 may be used to generate the application UI. For example, unlike conventional application development tools, interface 300 shown in FIG. 3 may be used to generate a container (or application) having one or more widgets, which can be displayed within prototype container (or application) preview interface 306. Interface 306 may include a visual representation of a target device for the application UI. For example, interface 306 of FIG. 3 includes a display of a tablet computing device. This interface may alternatively display a visual representation of a phone, laptop, or the like. To include the widget generated at block 4 within the application UI, the user may drag (or otherwise select and move) the preview image of the widget displayed in widget preview interface 304 onto the device displayed in prototype container preview interface 306 at any desired location. The user may position any number of widgets within the prototype container shown in interface 306. In this way, the user is provided an easy and intuitive way to create the layout of an application UI in a WYSIWYG interface. In some examples, the application development tool may allow the user to view the prototype container in a full screen view 700, as shown in FIG. 7.

Similar to widget preview interface 304, prototype container interface 306 may include a “Preview,” “Code Preview,” and “Settings” tab to view various types of data associated with the prototype container. For example, the arrangement of widgets, source code, settings, action mapping (e.g., a button widget can have a “click” action mapped to it that will call an entity API to update data or a dropdown menu widget can display data received from an entity API), and the like, can be edited using interface 300 of the application development tool. Specifically, the container appearance can be viewed using the “Preview” tab, the source code of the container can be viewed and edited using the “Code Preview” tab, and the container settings (e.g., themes and the like) can be viewed and edited using the “Settings” tab.

To illustrate, FIG. 5 shows an example view of prototype container interface 306 when the “Code Preview” tab is selected. Specifically, the source code associated with the container may be displayed within interface 306. A user may directly edit the displayed source code and the application development tool may apply the edited source code to the container. FIG. 6 shows an example view of prototype container interface 306 when the “Settings” tab is selected. Specifically, available settings, such as “Themes,” associated with the container may be displayed within interface 306. A user may type or select an option from a pull-down menu within interface 306 and the application development tool may apply the entered/selected options to the container. Using the various options provided in prototype container interface 306, the user may view and edit a container until the container includes the properties and appearance desired by the user. By providing a graphical user interface (e.g., under the “Settings” or “Mappings” tab) and a source code view (e.g., under the “Code Preview” tab), the application development tool allows a user to modify the container by directly editing the source code or by using an intuitive interface that does not require programming knowledge.

In addition, the application development tool may allow a user to adjust a height, width, and page-level attributes (e.g., global CSS styles, HTML meta tags, inclusion of external files, and the like) associated with the container. This may allow a user to modify the container for deployment on various types of target platforms.

Once the user has finished editing the container, the source code may be stored for later use or may be exported as a package of files that may include the generated source code and dependent files. In some examples, the application development tool may generate CSS, JavaScript, or JavaScript template files.

Thus, at block 5 of process 200, the application development tool may cause a display of a visual representation, source code, and/or settings associated with the prototype container. The application development tool may further receive one or more changes to the container layout or a widget included within with the container and may apply those changes to the container. In some examples, the received changes may include changes to the source code associated with the container. In other examples, the changes may include input received in a graphical user interface that may cause the application development tool to edit the source code associated with the container using pre-generated segments of code.

By integrating the application development tool with the entity and controller APIs, the application development tool may query the platform for API definitions and map the API properties to a widget, effectively generating source code utilizing these APIs. As a result, an application developer may save time both in writing code to access the APIs, as well as writing code to render UI widgets.

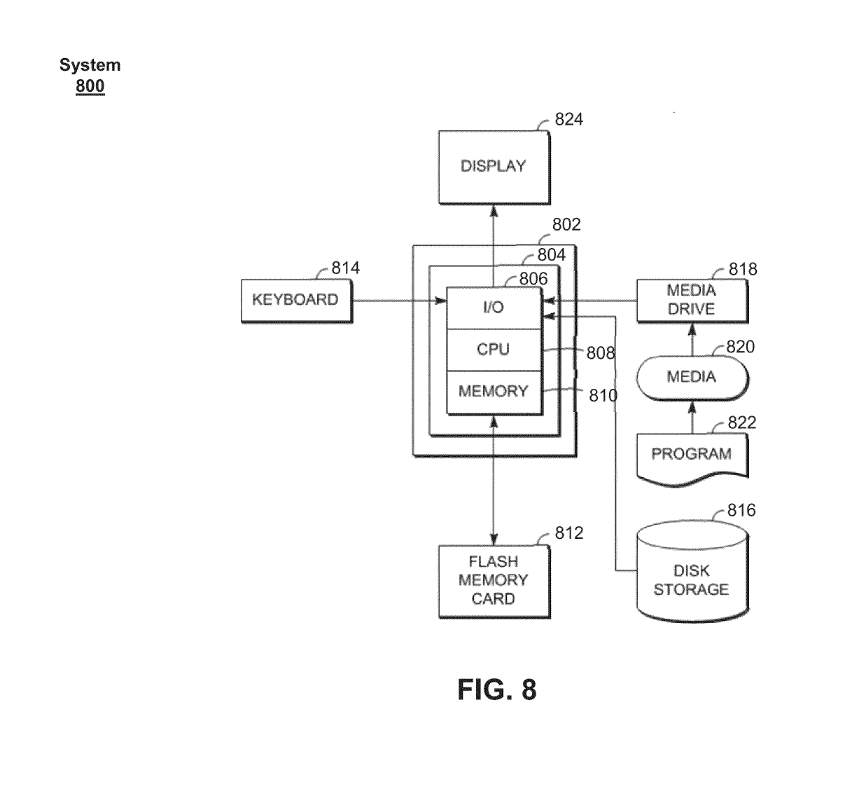

FIG. 8 depicts an exemplary computing system 800 configured to perform any one of the above-described processes. In this context, computing system 800 may include, for example, a processor, memory, storage, and input/output devices (e.g., monitor, keyboard, disk drive, Internet connection, etc.). However, computing system 800 may include circuitry or other specialized hardware for carrying out some or all aspects of the processes. In some operational settings, computing system 800 may be configured as a system that includes one or more units, each of which is configured to carry out some aspects of the processes either in software, hardware, or some combination thereof.

FIG. 8 depicts computing system 800 with a number of components that may be used to perform the above-described processes. The main system 802 includes a motherboard 804 having an input/output (“I/O”) section 806, one or more central processing units (“CPU”) 808, and a memory section 810, which may have a flash memory card 812 related to it. The I/O section 806 is connected to a display 824, a keyboard 814, a disk storage unit 816, and a media drive unit 818. The media drive unit 818 can read/write a computer-readable medium 820, which can contain programs 822 or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of the present disclosure. For example, aspects of embodiments disclosed above can be combined in other combinations to form additional embodiments. Accordingly, all such modifications are intended to be included within the scope of the present disclosure.

What is claimed is:

1. A computer-implemented method for developing an application, the method comprising:
receiving, at a processor, a selection of a first widget, wherein the first widget includes at least one widget attribute;
causing a display of a first set of available properties that can be mapped to the at least one widget attribute of the first widget;
receiving a selection of a property of the first set of available properties to be mapped to the at least one widget attribute of the first widget;
mapping the selected property of the first set of available properties to the at least one widget attribute of the first widget;
receiving a request to include the first widget within an application; and
including the first widget within the application.

2. The computer-implemented method of claim 1 further comprising:
receiving a selection of a second widget, wherein the second widget includes at least one widget attribute;
causing a display of a second set of available properties that can be mapped to the at least one widget attribute of the second widget;
receiving a selection of a property of the second set of available properties to be mapped to the at least one widget attribute of the second widget;
mapping the selected property of the second set of available properties to the at least one widget attribute of the second widget;
receiving a request to include the second widget within the application; and
including the second widget within the application.

3. The computer-implemented method of claim 1 further comprising exporting the application as a plurality of files.

4. The computer-implemented method of claim 1, wherein the first set of available properties are selected from a plurality of properties based on the at least one widget attribute of the first widget.

5. The computer-implemented method of claim 1, wherein mapping the selected property comprises modifying source code associated with the first widget to associate the selected property of the first set of available properties to the at least one widget attribute of the first widget using a pre-generated segment of code.

6. The computer-implemented method of claim 1 further comprising causing a display of an application development tool interface, wherein the application development tool interface comprises:
a widget selection interface for displaying a representation of a plurality of widgets;
a widget preview interface for displaying a preview of the first widget; and
an application preview interface for displaying a preview of the application.

7. The computer-implemented method of claim 6, wherein receiving the selection of the first widget comprises:
receiving a selection of the first widget from the plurality of widgets displayed within the widget selection interface.

8. The computer-implemented method of claim 6, wherein receiving the request to include the first widget within the application comprises:
receiving a selection of the first widget displayed within the widget preview interface; and
receiving a placement of the first widget within the preview of the application displayed within the application preview interface.

9. The computer-implemented method of claim 6, further comprising:
causing a display of source code associated with the first widget within the widget preview interface; and
causing a display of source code associated with the application within the application preview interface.

10. The computer-implemented method of claim 1, wherein including the first widget within the application comprises modifying source code associated with the application based on source code associated with the first widget.

11. A non-transitory computer-readable storage medium for developing an application, the non-transitory computer-readable storage medium comprising computer-executable instructions for:
receiving at a processor, a selection of a first widget, wherein the first widget includes at least one widget attribute;
causing a display of a first set of available properties that can be mapped to the at least one widget attribute of the first widget;
receiving a selection of a property of the first set of available properties to be mapped to the at least one widget attribute of the first widget;
mapping the selected property of the first set of available properties to the at least one widget attribute of the first widget;
receiving a request to include the first widget within an application; and
including the first widget within the application.

12. The non-transitory computer-readable storage medium of claim 11 further comprising:
receiving a selection of a second widget, wherein the second widget includes at least one widget attribute;
causing a display of a second set of available properties that can be mapped to the at least one widget attribute of the second widget;
receiving a selection of a property of the second set of available properties to be mapped to the at least one widget attribute of the second widget;
mapping the selected property of the second set of available properties to the at least one widget attribute of the second widget;
receiving a request to include the second widget within the application; and
including the second widget within the application.

13. The non-transitory computer-readable storage medium of claim 11 further comprising exporting the application as a plurality of files.

14. The non-transitory computer-readable storage medium of claim 11, wherein the first set of available properties are selected from a plurality of properties based on the at least one widget attribute of the first widget.

15. The non-transitory computer-readable storage medium of claim 11, wherein mapping the selected property comprises modifying source code associated with the first widget to associate the selected property of the first set of available properties to the at least one widget attribute of the first widget using a pre-generated segment of code.

16. The non-transitory computer-readable storage medium of claim 11 further comprising causing a display of an application development tool interface, wherein the application development tool interface comprises:
a widget selection interface for displaying a representation of a plurality of widgets;
a widget preview interface for displaying a preview of the first widget; and
an application preview interface for displaying a preview of the application.

17. The non-transitory computer-readable storage medium of claim 16, wherein receiving the selection of the first widget comprises:
receiving a selection of the first widget from the plurality of widgets displayed within the widget selection interface.

18. The non-transitory computer-readable storage medium of claim 16, wherein receiving the request to include the first widget within the application comprises:
receiving a selection of the first widget displayed within the widget preview interface; and
receiving a placement of the first widget within the preview of the application displayed within the application preview interface.

19. The non-transitory computer-readable storage medium of claim 16, further comprising:
causing a display of source code associated with the first widget within the widget preview interface; and
causing a display of source code associated with the application within the application preview interface.

20. The non-transitory computer-readable storage medium of claim 11, wherein including the first widget within the application comprises modifying source code associated with the application based on source code associated with the first widget.
